(19) United States
(12) Patent Application Publication
(10) Pub. No.: US 2019/0372349 A1
(43) Pub. Date: Dec. 5, 2019

(54) Idi

(71) Applicant: Tammara L. Brown, Liverpool, NY (US)

(72) Inventor: Tammara L. Brown, Liverpool, NY (US)

(21) Appl. No.: 16/425,932

(22) Filed: May 29, 2019

Related U.S. Application Data
(60) Provisional application No. 62/677,303, filed on May 29, 2018.

(51) Int. Cl. H02J 3/32

(52) U.S. Cl. CPC H02J 3/32

(57) ABSTRACT

The Idi is an energy device that can be plugged into a wall receptacle. The Idi uniquely uses a grid-tied inverter and a power inverter to convert rechargeable batteries or dc sources to ac power. When the grid voltage is on the grid-tied inverter supplements the power consumption when the Idi is plugged into a wall receptacle. However, when the grid voltage drops to zero the grid-tied inverter turns off. Hence the battery and load relay connections are the switched to the power inverter. Thus, making the Idi the main power supply for a load.

### FIELD OF THE INVENTION

This invention generally relates to the utilization of alternative energy sources. More specifically an electronic device that will allow a more accessible way to incorporate alternative energy use into daily life.

### BACKGROUND OF THE INVENTION

The alternative energy market lacks a device to make the use of alternative energy more widespread. Currently, the incorporation of alternative energy sources is inaccessible due to the high cost of current devices on the market, installation cost, limitations on collection of resources, and a slow to no return on investment. Devices such as The Tesla Wall is inaccessible for people who don't own their home, because it requires an installation. Moreover, the installation is expensive and would require a professional to install. Most Alternative Energy devices don't offer scalability in the form of battery size and devices in the home. The alternative energy market needs a more accessible device.

### SUMMARY

The Idi is an energy device that plugs into an electrical outlet. When the Idi is plugged into the electrical outlet it can acts as a primary and supplemental power source. The power supplied by the Idi comes from the rechargeable Lithium-ion batteries and or other dc sources. The Idi eliminates the installation cost, allows for users to choose how the batteries are charged. Moreover, the portability, and no installation cost of the Idi. The Idi brings accessibility through its' battery scalability, portability, and ease of use.

### A BRIEF DESCRIPTION OF DRAWING

FIG. 1 is a block diagram of the Idi that depicts how the components of the Idi are connected.

FIG. 2 is an exploded view of the relay terminal assignments with the load.

FIG. 3 is an exploded view of the relay terminal assignments with the battery packs.

### DETAILED DESCRIPTION

The terminology used herein is for the purpose of describing a particular embodiment only and is not intended to be limiting of the invention. As used herein, the term “and/or” includes any and all combinations of one or more of the associated listed items. As used herein, the singular forms “a,” “an,” and “the” are intended to include the plural forms as well as singular forms, unless the context clearly indicates otherwise. It will be further understood that the terms “comprises” and/or “comprising” when used in the specification, specify the presence of the stated features, steps. Operations, elements, and/or components, but do not preclude the presences or addition of one or more other features, steps, operations, elements, components, and/or groups thereof.

Unless otherwise stated all terms (including technical and scientific terms) used herein have the same meaning as a commonly understood by one having ordinary skills in the art to which this invention belongs. It will be further understood that terms, such as those defined in commonly used dictionaries, should be interpreted as having a meaning that is consistent with their meaning in the context of relevant art and the present disclosure and will not be interpreted in an idealized or overly formal sense unless expressly so defined.

In describing the invention, it will be understood that a number of techniques and steps are disclosed. Each of these has the individual benefit and each can also be used in conjunction with one or more, or in some cases all, of the disclosed techniques. Accordingly, for the sake of clarity, his description will refrain from reaping every possible combination of individual steps in an unnecessary fashion. Nevertheless, the specification and claims should be read with the understanding that such combinations are entirely within the scope of the invention and the claims.

The Idi device and method for usage are discussed herein. In the following description, for purpose of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to a specific embodiment illustrated by the figures of the description below. The detailed description below is the preferred embodiment and usage. As with circuit configuration, there are different ways to produce the same outcome.

Design Parameters The described Idi below is designed on the parameters of the average North American house voltage and current maximums. The Idi's components can be changed to fit the needs of different voltage and current maximums.

Some of the latter mentioned parts will need to be soldered. How to solder is known, but the added steps for protection needs to be explained. When soldering XT60 female connector or the male plug to a 14 AWG wire with exposed ends, using Anchor adhesive heat shrink tubes, and proper wire connection is needed. Before beginning to solder place a heat shrink tube on the wire below the exposed end. Then make sure the wires line up with their respective sign. An example is the dc connection of the black with the negative and the red with the positive. Soldering the wires to the protruding gold ends of the XT60 connector. Then pushing the heat shrink over the soldered section and apply some with a blow dryer or something suitable to shrink the tube around the exposed soldered wire. These steps are for safety and durability of the connections.

The cords referenced in the following description will be a 14/2 or a 14/3 AWG. Inside a 14/2 AWG cord are two copper wires. Inside a 14/3 AWG cord are 3 wires. Also, it should be noted that the power cords used being either 14/2 or 14/3 have a male electrical plug on one end and exposed copper wire at the other end.

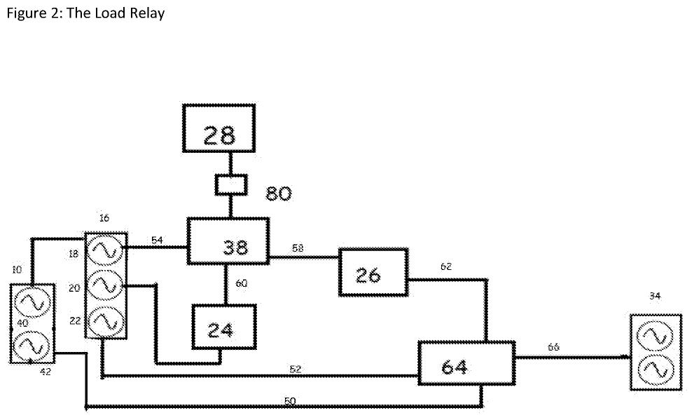

FIG. 2 is a representation of the terminal assignment for the Potter & Brumfield K10P-11A15-120-part number 413931440 relay. The Potter & Brumfield K10P-11A15-120 is the preferred Relay used to switch the circuit between the different components. Using the alphanumeric terminal assignments given by the manufacturer to detail where to connect the components to the relay. Herein 38 will be called the “Battery Relay,” and 64 will be referred to as the “Load Relay.” Here in the terminal assignments will be referred to as “Pin(s).” Pins 1 and 2 are the “Normally Closed” pins. Pins 3 and 4 are the “Normally Open” pins. Pins 5 and 6 are the “Common” pins. Pins A and B are the “Coil” pins.

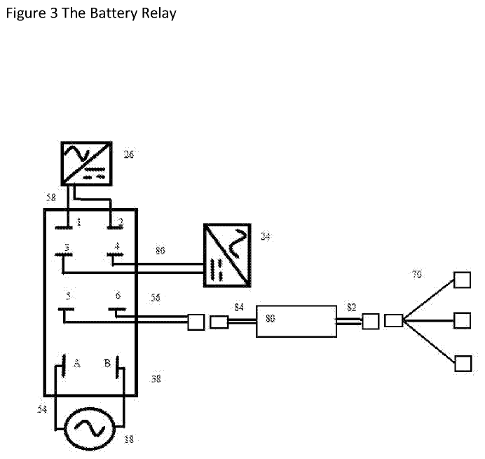

Referencing FIG. 3 to detail the connections to 38. The Battery Relay connects to 28, 26, and 24. 28 is a representation the combined battery pack. The preferred battery packs are the Mboards 10s 2p Lithium-ion battery packs. The packs each have a battery management system attached that isn't shown. The battery terminals have XT60 male plugs at the end. Each male plug will be plugged into one of female ends of 70. 70 is a three-way parallel XT60 connector. This connector makes it possible to combine the three battery packs in parallel. The male end of 70 will then connect to the female XT60 connector of 82. As shown in FIG. 3 the XT60 male and female connectors aren't connected for description purposes. 82 is a 14 AWG battery wire on the source side of 80 that has a female XT60 connector soldered to its end. 80 is a Tenergy Watt Meter and Power Analyzer. 80 is responsible for giving a visual display of the battery packs combined power level. Then on the load side of 80 is 84 a 14 AWG battery wire with an XT60 male plug soldered at its end. Then 84 connects to 56 a 14 AWG battery wire with female XT60 on the end. 56 is connected to the Battery Relay by soldering the black wire to pin 6 and the red wire to pin 5 on 38. Herein “grid” is a reference to the ac voltage coming from the power grid. 38 the Battery Relay is responsible for the switching the batteries connection between 24 a Solinba 1000w Pure Sine Wave Grid Tie Power Inverter, and 26 an Aims 1500-Watt 48 Volt Pure Sine Inverter PWRIS500485. 26 is responsible for converting the dc voltage from the batteries to an ac voltage. 26 is connected to 38 via 58. 58 is a set of 14 AWG copper battery wire with cable shoe on one end. With the nuts removed from the red and black terminals on 26, the cable shoes on the wires are then placed on the color matching dc terminals on 26. Screwing the nuts back on to each terminal will secure the cable shoes of 58 to 26. The exposed copper end of the wires is then connected to 38 by soldering the black wire to pin 2 and the red wire to pin 1. 24 is responsible for converting the dc voltage to a grid matching ac voltage when connected to the grid. 24 is connected to 38 via 60. 60 is a 14 AWG copper battery wires with cable shoes at one end and exposed copper at the other end. The battery terminal screw caps on 24 are removed then the cable shoe connected to the back wire in place on the black terminal of 24. Then the cable shoe connected to the red wire is placed on the red terminal of 24. Then the wires are secured by screwing the black and red caps on respectively. The exposed copper ends of the black and red wires are soldered to pins 4 and 3 respectively. Next on the Battery Relay are pins A and B the coil pins. Pins A and B drive the switch the connect the common pins to the normally open pins or to the normally closed pins. The coils in this relay is driven by an ac voltage. That voltage is supplied by 18 a grid outlet connection via cord 54. 54 is a 14/2 AWG ac copper power cord with a male electrical plug. The black wire is soldered to pin B and the white wire is soldered to pin A.

Referencing FIG. 4 to detail the connections to 34 and its power sources. Herein the name “Load” is a reference to any power drawing device connected to the circuit at 34. Herein 64 will be referred to as the “Load Relay.” Connected to the Load Relay are electrical outlets 42, 22, 26 the inverter, and 34 the load connection of the circuit. Electrical outlet 22 is connect to the Load relay via cord 52. 52 is a 14/2 AWG ac copper wire power cord with a male electrical plug. The male end of 52 plugs into 22. Then white and black exposed copper wires are soldered to pins A and B on the Load Relay respectively. 26 the Aims Inverter is connected to the Load Relay via 62 a 14/3 AWG ac copper wire power cord with a three-prong male electrical plug. 62's black wire is soldered to pin 2 and the white is soldered to pin 1. The male plug end of 62 is plugged into an outlet port on 26. 42 is connected to the Load Relay via 50 a 14/3 AWG ac copper wire power cord with a three-prong male electrical plug. Soldering the exposed copper end of the black wire to pin 4 and the white wire to pin 3. 34 is a The Enerlites 61580-W duplex electrical outlet receptacle. 34 is the load connection. Using 66 a 14/3 AWG ac copper wire power cord with a three-prong male electrical plug that connects 34 to 64. The exposed copper ends of the black wire are soldered to pin 6 and the white wire is soldered to pin 5. Then the other end of 66 is secured to the The Enerlites 61580-W duplex electrical outlet receptacle. The white, and black wires of 66 connect to the silver, and brass colored screws respectively on 34. Creating a hook on each wire so that it has a snug fit around its respective screw. Then tighten the screws so that the wires are secured. The exposed copper ends from the green wires from cords 50, 66, and 62 are pig-tailed together using an 8-inch length of 14 AWG bare copper wire. Then the bare copper wire end is hooked around the green screw on 34. Then the pig-tailed wire is secured into place by tightening the screw.

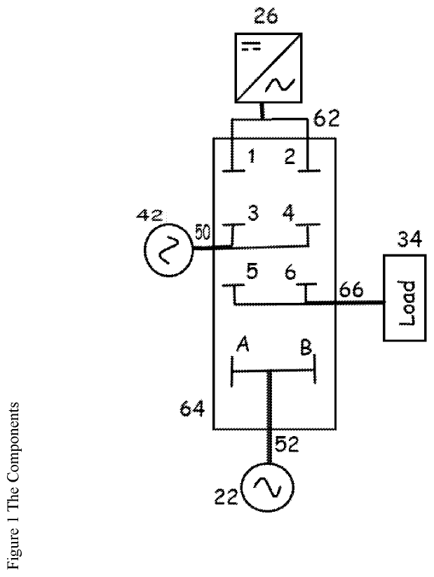

Referencing FIG. 1 is a preferred example of the Idi box diagram. 16 a three-outlet power strip, is used to split the voltage in parallel. The power strip can be any power strip with at least three outlets. The power strip will be used to control the Load and Battery Relay switch mechanisms and connect the 24 to the grid. 16 contains outlets 18, 20 and 22. Outlet 18 connects to 38 via 54. 54 is a 14/2 AWG copper wire power cord with a male electrical plug. The male end of cord 54 plugs into outlet 18 and the other end is soldered to 38 as previously mentioned. Connected to 38 are 30, 24 and 26. 26 is the Aims inverter that is connected to 38 as previously detailed. 24 is the Solinba grid-tied inverter that connects to 38 as previously detailed. Then with the 68 turned on and the battery packs connected the device can be connected to the grid. 50 is a 14/3 AWG copper wire power cord with a male electrical plug is then plugged into 42. Then the power cord from 16 is plugged into 18. Then the inverters can be turned on.

After power cord 50 and the power strip 16 has been plugged into outlets 40 and 42 the inverters can be turned on. Then a device may be plugged into 34. Not pictured is a housing for the components of the Idi. Preferred housings would include access to the on/off buttons and switches of the inverters. Also preferred is access to the XT60 female connector on 56 should be available. Also, a preferred housing includes adequate ventilation, access 70 the battery connector, and setting 80 so the battery information is visible outside the housing.

### CONCLUSION

Although this invention has been described in specific detail with reference to the disclosed preferred embodiment it will be understood that many variations and modifications may affected within the spirit and scope of the invention as described in the appended claims. The uniqueness of the Idi is to use batteries and or dc sources of energy through two inverters to power device with or without grid ac power. Obviously, many modification and variation of the present invention are possible in light of the teaching above. The components of the Idi can be scaled up or down to meet the demand of voltage and current for different settings. Moreover, the female outlets and male prongs described can be changed to fit specific country standards. The Idi is cab be upgraded because of its battery and inverter connections. The Lithium-ion battery pack sizes allow for versatile battery charging. The battery packs can also be change to another dc energy source such as a solar panel. Also 70 the XT60 connector between 80 and the battery packs can be changed to another XT60 connector of any orientation to fit the voltage and current demands. Also, the preferred XT60 connector can be change to different connectors such as a XT90 or any other suitable wire connector. Likewise, with the inverters they can be replaced with other inverters to fit the voltage, current, and wattage demands. The relays can also be replaced by Triacs to act a type of switch. The purpose of the two inverters is when the grid voltage is zero the 24 shuts down and no longer uses the 28 the rechargeable Li-ion batteries. However, when the grid voltage is zero 38 switches 28 connection from 24 the grid-tied inverter to 26 the power inverter. Moreover, when the grid voltage is zero 64 the Load Relay switches 34 the load connection from 42 the grid outlet to 26 the power inverter. Affirming that the Idi is both a supplemental and main energy source. Additional software and devices can be added to the Idi to provide more advanced battery monitoring and usage features. Features including but not limited to better time usage of batteries, and phone applications. Extra features can improve the energy consumption from the grid. Another feature would be to add intermittent power supply to the Idi. The power supply would provide instantaneous power when the grid voltage drops below the relays threshold for switching to normally open pins. Therefore, still providing power to the load. This intermittent power supply can be achieved by adding rectifier and capacitor to the circuit. The duplex out part can also be change to a power strip with more outlet and add USB ports as well. The Idi brings versatility to the home battery market in both design and usage.

1. The Idi is an energy device comprising: A Grid Tied inverter, ADC to AC inverter, A battery pack, electrical wiring, and relays.

2. The Idi plugs into an electrical outlet receptacle

3. The components of claim 1 and the function of claim 2 where said components and function tallow The Idi to be used both on and off the grid.

4. The components of claim 1 wherein the said inverters have variable voltage and current tolerances and outputs.

5. The components of claim 1 wherein the said battery pack can have a range of Kilowatt hours, The Idi

6. The Idi can be connected other DC sources of energy.
